(19) United States
(12) Patent Application Publication
(10) Pub. No.: US 2008/0214046 A1
(43) Pub. Date: Sep. 4, 2008

(54) Connecting device having a locking mechanism

(76) Inventors: Yoshihiro Sugii, Tokyo (JP); Kazuhiko Furukatsu, Tokyo (JP); Makoto Hayashi, Tokyo (JP); Hiroyuki Maeda, Tokyo (JP); Katsushiro Ishibayashi, Tokyo (JP)

Correspondence Address: COLLARD & ROE, P.C., 1077 NORTHERN BOULEVARD, ROSLYN, NY, 11576, US

(21) Appl. No.: 11/881,348

(22) Filed: Jul. 26, 2007

(30) Foreign Application Priority Data
Jul. 28, 2006 (JP) 2006-206583

(51) Int. Cl. H01R 13/639

(52) U.S. Cl. 439/567

(57) ABSTRACT

A connecting device has a locking mechanism for locking fitting between a first connecting member and a mating side. The locking mechanism has a first elastic body and a second elastic body. The first elastic body has a first contact portion adapted to contact the mating side. The second elastic body has a second contact portion adapted to contact the mating side. At least one of the first elastic body and the second elastic body has a locking portion adapted to lock fitting to the mating side.

This application claims priority to prior Japanese patent application JP 2006-206583, the disclosure of which is incorporated herein by reference.

### BACKGROUND OF THE INVENTION

This invention relates to a connecting device having a locking mechanism.

As a related art 1, there is a structure for mounting an antenna device with a pigtail harness to a roof panel of a vehicle.

In the operation of mounting the antenna device to the roof panel, a cable is, at first, passed through an antenna mounting hole, formed in the roof panel, from the outside of the roof panel and, then, the cable is gropingly pulled into the inside of the vehicle. Then, the cable is passed through a mounting nut and the nut is tightened using a fastening tool while the nut is supported by hand.

Further, Japanese Unexamined Patent Application Publication (JP-A) No. H09-283230 (Patent Document 1) as a related art 2 discloses a connector holding structure wherein a connector on the side of a component and a connector on the side of a panel are fitted together so that the component is detachably mounted.

In this connector holding structure, a first connecting body having the connector fixed to the component and a second connecting body having the connector disposed on the side of the panel are fitted together by bolts and nuts.

A temporary engaging portion is provided on the side of the first connecting body and a temporary locking portion is provided on the side of the second connecting body. The temporary engaging portion and the temporary locking portion are employed for increasing an engaging force to the panel.

Further, Japanese Unexamined Patent Application Publication (JP-A) No. H05-335056(Patent Document 2) as a related art 3 discloses a body fixing connector to be fitted with a mating connector. This body fixing connector is fixed to a vehicle body by locking it to the vehicle body. A movable locking portion of the body fixing connector has a locking pawl that is locked to a connector mounting hole of the vehicle body upon passing through a flange portion.

In the related art 1, the cable is gropingly pulled into the inside of the vehicle and the nut is tightened using the fastening tool while the nut is supported by hand.

Therefore, since the operation extends over the inside and outside of the vehicle when mounting the antenna device to the roof panel, there is a problem that the operation is complicated and difficult.

Further, in the connector holding structure of Patent Document 1, there is a problem that if an engaging force between the temporary engaging portion and the temporary locking portion is strengthened for increasing the engaging force to the panel, a large force is required at the time of mounting.

Further, in the body fixing connector of Patent Document 2, there is a problem that if an elastic force of the movable locking portion is strengthened for increasing a holding force of the movable locking portion, a large force is required at the time of mounting.

### SUMMARY OF THE INVENTION

It is therefore an exemplary object of this invention to provide a connecting device having a locking mechanism that allows insertion with a low insertion force at the time of mounting and still exerts a high holding force.

It is another exemplary object of this invention to provide a connecting device having a locking mechanism that can simplify the mounting operation.

Other objects of the present invention will become clear as the description proceeds.

According to an exemplary aspect of of the present invention, there is provided a connecting device having a locking mechanism for locking fitting between a first connecting member and a mating side, wherein the first connecting member comprises a first housing, the first housing has the locking mechanism, the locking mechanism comprises a first elastic body and a second elastic body, the first elastic body has a first contact portion adapted to contact the mating side, the second elastic body has a second contact portion adapted to contact the mating side, at least one of the first elastic body and the second elastic body has a locking portion adapted to lock fitting to the mating side.

### BRIEF DESCRIPTION OF THE DRAWINGS

FIG. 1 is a perspective view showing a first connecting member of a connecting device having a locking mechanism according to a first embodiment of this invention;

FIG. 2 is a perspective view showing a second connecting member for connection to the first connecting member shown in FIG. 1;

FIG. 3 is an enlarged perspective view enlargedly showing part of the first connecting member shown in FIG. 1;

FIG. 4 is a perspective view showing a state where the first connecting member shown in FIG. 1 is applied to an antenna device and attached to a roof panel;

FIG. 5 is a perspective view for explaining a mounting state of the antenna device shown in FIG. 4;

FIG. 6 is a perspective view showing a state where the antenna device shown in FIG. 5 is detached from the roof panel and a pad is removed;

FIG. 7 is a perspective view showing a fixing device, the second connecting member, and a cover body shown in FIG. 6;

FIG. 8 is a perspective view showing the fixing device and a base member shown in FIG. 6;

FIG. 9 is an explanatory diagram showing a state before the first connecting member and the second connecting member shown in FIGS. 1 and 2 are fitted together;

FIG. 10 is an explanatory diagram showing a temporary assembly state of the first connecting member and the second connecting member shown in FIG. 9;

FIG. 11 is an explanatory diagram showing a state where the first connecting member and the second connecting member shown in FIG. 10 are fitted together;

FIG. 12 is a sectional view showing a connecting device having a locking mechanism, in a state before fitting, according to a second embodiment of this invention; and

FIG. 13 is a sectional view showing a fitting state of the connecting device having the locking mechanism shown in FIG. 12.

### DESCRIPTION OF THE PREFERRED EMBODIMENTS

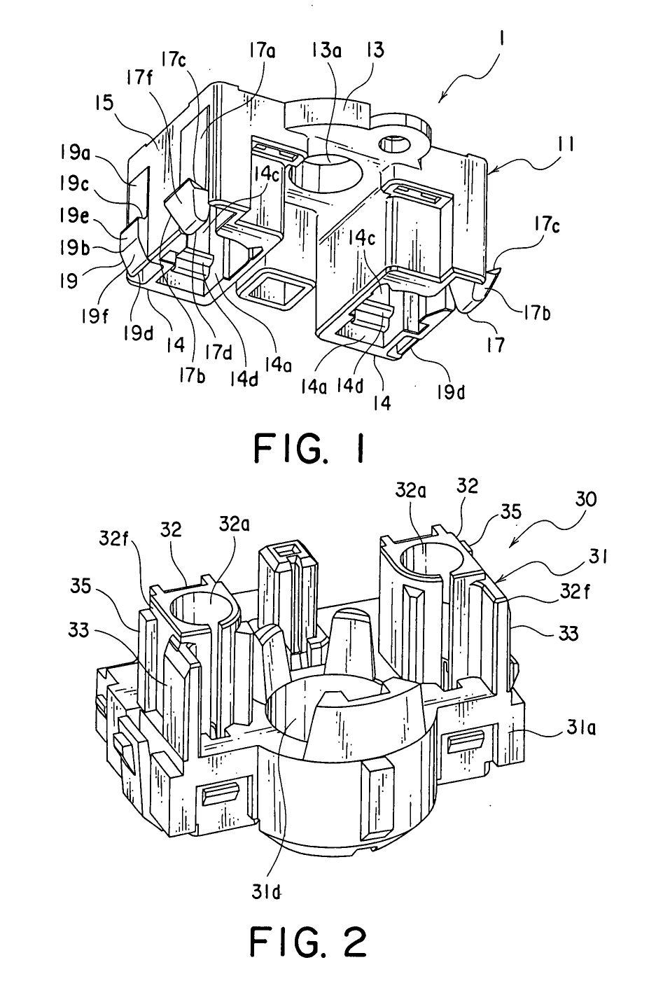

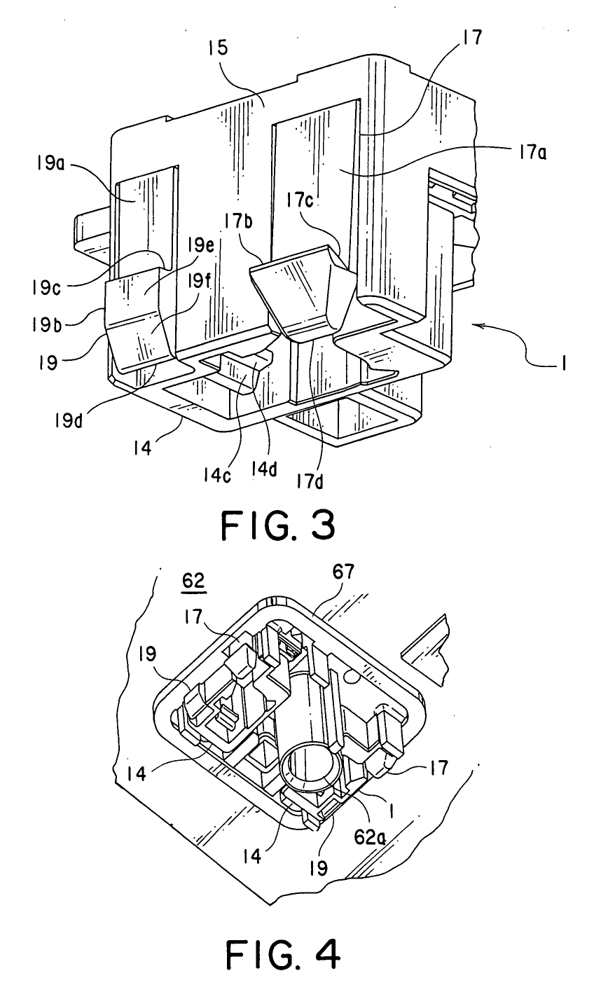

FIG. 1 shows a first connecting member of a connecting device having a locking mechanism according to a first embodiment of this invention. FIG. 2 shows a second connecting member of the connecting device for connection to the first connecting member. FIG. 3 enlargedly shows part of the first connecting member.

The connecting device of the first embodiment is applied to an antenna device that is mounted to a roof panel of a vehicle serving as a mating side. A first connecting member 1 shown in FIG. 1 is attached to a non-illustrated mounting hole formed in the roof panel. A second connecting member 30 shown in FIG. 2 is connected to the first connecting member 1.

Referring to FIGS. 1 and 3, the first connecting member 1 has a first housing 11 of an insulating material. The first housing 11 has a plate-shaped first base portion 13, a pair of first block portions 14 respectively standing upright on the first base portion 13, and a locking mechanism formed at an outer surface of a sidewall portion 15 on one side of each of the first block portions 14.

The first block portions 14 are provided upright on the first base portion 13 on both left and right sides in FIG. 1, respectively.

At each of the first block portions 14, the locking mechanism comprises a first elastic body 17 connected to the sidewall portion 15 on the side of the first base portion 13 and a second elastic body 19 connected to the sidewall portion 15 on the side of the first base portion 13.

The locking mechanism serves to lock the first connecting member 1, being attached to the roof panel, so as to prevent it from coming off the roof panel.

The first elastic body 17 has an elongated plate-shaped first elastic plate portion 17a. One end of the first elastic plate portion 17a on the side of the first base portion 13 is connected to the corresponding one of the sidewall portions 15 opposed in parallel to each other. The first elastic body 17 has a free end portion formed with a first contact portion 17b projecting from the first elastic plate portion 17a.

The second elastic body 19 has an elongated plate-shaped second elastic plate portion 19a. One end of the second elastic plate portion 19a on the side of the first base portion 13 is connected to the corresponding one of the sidewall portions 15 opposed in parallel to each other. The second elastic body 19 has a free end portion formed with a second contact portion 19b projecting from the second elastic plate portion 19a.

When inserting the first connecting member 1 through the mounting hole of the roof panel, the first contact portions 17b are each pressed by contact with the inner edge of the mounting hole. When inserting the first connecting member 1 through the mounting hole of the roof panel, the second contact portions 19b are each pressed by contact with the inner edge of the mounting hole.

The first elastic bodies 17 serve to guide the first connecting member 1 when attaching the first connecting member 1 to the mounting hole. Further, after the first elastic bodies 17 are elastically deformed, the second contact portions 19b contact the inner edge of the mounting hole so that the second elastic bodies 19 are elastically displaced.

The first elastic bodies 17 absorb a clearance of the locking mechanism and accordingly serves as assist springs for controlling a posture of the first connecting member 1. The second elastic bodies 19 serve as a friction locking mechanism for locking engagement with the roof panel. Therefore, the locking mechanism allows insertion with a low insertion force and still exerts a high holding force.

The first contact portion 17b has a first locking portion 17c for holding the fitting to the roof panel in a locked state. The first locking portion 17c is a surface of a stepped portion projecting in a direction perpendicular to the surface of the first elastic plate portion 17a.

The second contact portion 19b has a second locking portion 19c for locking the fitting to the roof panel. The second locking portion 19c is a surface of a stepped portion projecting in a direction perpendicular to the surface of the second elastic plate portion 19a.

A tip 17d on the free end side of the first contact portion 17b of the first elastic body 17 extends more than a tip 19d on the free end side of the second contact portion 19b of the second elastic body 19.

Further, the first contact portion 17b has a first inclined surface 17f formed so as to be inclined from the side of the first locking portion 17c to the tip 17d on the free end side of the first contact portion 17b.

The second contact portion 19b has a flat surface 19e formed extending from the side of the second locking portion 19c so as to be parallel to the second elastic plate portion 19a and a second inclined surface 19f inclined from the flat surface 19e to the tip 19d on the free end side of the second contact portion 19b.

The first inclined surfaces 17f of the first contact portions 17b contact the inner edge of the mounting hole of the roof panel when attaching the first connecting member 1 to the roof panel. In this event, the first elastic bodies 17 are elastically deformed due to contact of the first contact portions 17b with the inner edge of the mounting hole. After the first elastic bodies 17 are elastically deformed, the second contact portions 19b contact the inner edge of the mounting hole of the roof panel. In this event, the second elastic bodies 19 are elastically deformed due to contact of the second inclined surfaces 19f of the second contact portions 19b with the inner edge of the mounting hole.

While the flat surfaces 19e of the second contact portions 19b are in contact with the inner edge of the mounting hole of the roof panel, the elastic deformation of the second elastic bodies 19 is in a saturated state. In this event, since the first inclined surfaces 17f of the first contact portions 17b are in contact with the inner edge of the mounting hole, the first elastic bodies 17 are in a state to be further elastically deformed.

The first block portions 14 are each formed with a first fitting hole 14a extending from the first base portion 13 through a tip surface of the first block portion 14. A first contact (not shown) is provided in the first fitting hole 14a. The first connecting member 1 provided with the first contacts serves as one of connectors.

The first connecting member 1 is connected to the second connecting member 30 shown in FIG. 2. The second connecting member 30 has a second housing 31 of an insulating material.

The second housing 31 has a second base portion 31a and a pair of second block portions 32 provided for fitting into the first fitting holes 14a of the first housing 11, respectively.

When the first connecting member 1 and the second connecting member 30 are fitted and connected together, the first block portions 14 and the second block portions 32 are fitted together. In this event, the second block portions 32 are fitted into the first fitting holes 14a of the first housing 11, respectively.

A rib-shaped first limiting portion 33 for limiting elastic deformation of the corresponding first elastic body 17 is formed on an outer surface of a sidewall portion 32f of each of the second block portions 32. Further, a plate-shaped second limiting portion 35 is formed on the outer surface of the sidewall portion 32f of each block portion 32. The second limiting portion 35 serves to limit elastic deformation of the corresponding second elastic body 19 when the first connecting member 1 and the second connecting member 30 are connected together.

The second block portions 32 are each formed with a second fitting hole 32a. A second contact (not shown) for connection to the first contact at the time of fitting is provided in each of the second fitting holes 32a. The second connecting member 30 provided with the second contacts serves as the other of the connectors.

A first through hole 13a (see FIG. 1) is formed at a substantially central portion of the first base portion 13 of the first connecting member 1. A second through hole 31d is formed at a substantially central portion of the second connecting member 30.

FIG. 4 shows a state where the first connecting member 1 is attached to a roof panel 51. As shown in FIG. 4, a tubular portion 62a standing upright on a base member 62 is inserted through the first through hole 13a. Further, when the first connecting member 1 and the second connecting member 30 are fitted together, the tubular portion 62a is inserted through the second through hole 31d.

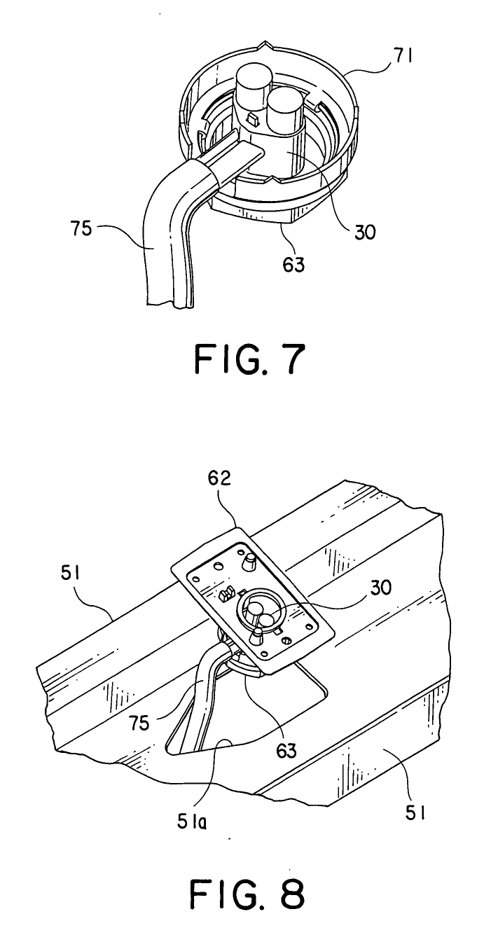

As shown in FIGS. 4 to 8, an antenna device using the first connecting member 1 and the second connecting member 30 comprises an antenna body 61 disposed on one side of the roof panel 51 and a fixing device 63 (see FIG. 6) located on the other side of the roof panel 51. The fixing device 63 serves to completely fix the antenna body 61 to the roof panel 51.

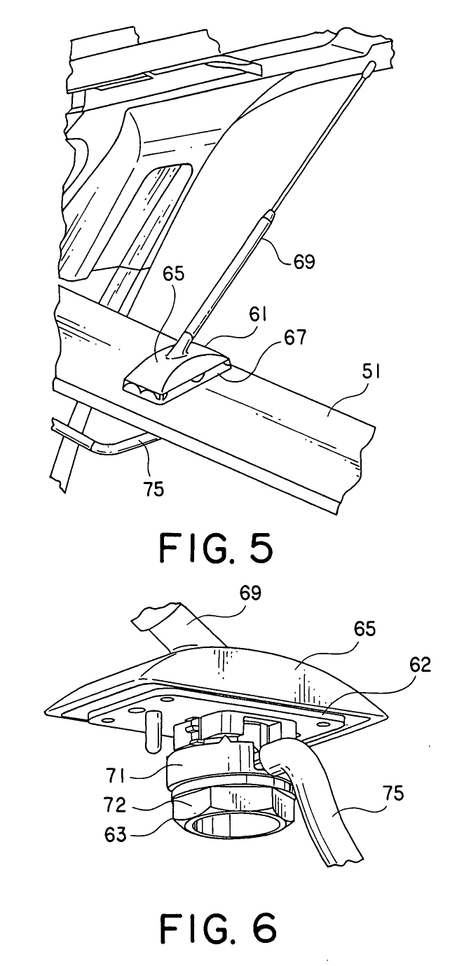

The antenna body 61 comprises an antenna cover 65 and a pad 67 (see FIGS. 4 and 5) interposed between the antenna cover 65 and the roof panel 51. The antenna cover 65 is attached with an antenna element 69 for radio or television. The base member 62 is mounted in the antenna cover 65. A patch antenna (not shown), a board (not shown) provided with a circuit, and the first connecting member 1 are mounted on the base member 62.

The fixing device 63 comprises a bottomed cylindrical cover body 71 made of a conductive material such as, for example, stainless steel or nickel-plated iron, and a nut 72. The cover body 71 urges the first connecting member 1 upward. A coaxial cable 75 is connected to the second contacts provided in the second connecting member 30.

Assembly of the antenna device is roughly divided into three processes. That is, the first process is a process of temporarily attaching the first connecting member 1 and the antenna body 61 to the roof panel 51. The second process is a process of temporarily attaching the second connecting member 30 and the fixing device 63 to the first connecting member 1. The third process is a process of clamping/fixing the antenna body 61 to the roof panel 51.

In the first process, at first, the pad 67 is positioned around a mounting hole 51a (see FIG. 8) on the roof panel 51 and the first connecting member 1 is inserted into the mounting hole 51a. In this event, the first and second contact portions 17b and 19b of the first and second elastic bodies 17 and 19 are pressed against the inner edge of the mounting hole 51a when passing through the mounting hole 51a.

Therefore, the first and second elastic plate portions 17a and 19a of the first and second elastic bodies 17 and 19 pass through the mounting hole 51a while bending. Then, after the first and second contact portions 17b and 19b have passed through the mounting hole 51a, they return to the original shape and project from the mounting hole 51a.

In the first process, the first connecting member 1 is temporarily attached to the roof panel 51 by engagement of the first and second locking portions 17c and 19c of the first housing 11 with the back side of the roof panel 51. Only one of the first or second locking portions 17 or 19 may be formed. The composition of the locking portions 17c or 19c to which only either of them is formed is acceptable. In the second process, the second connecting member 30 and the fixing device 63 are temporarily attached to the first connecting member 1 by insertion into the first connecting member 1.

Further, in the third process, the antenna device is assembled and fixed to the roof panel 51 by tightening the nut 72 of the fixing device 63. In this event, the first contacts and the second contacts are electrically connected together.

In each of the first fitting holes 14a of the first connecting member 1, there is formed an additional elastic body 14c (see FIGS. 1 and 3) extending parallel to the axial direction of the first fitting hole 14a from the first base portion 13. A stripe-shaped first additional locking portion 14d is formed at a free end portion of the additional elastic body 14c. When the second connecting member 30 shown in FIG. 2 is inserted and connected to the first connecting member 1, the additional elastic bodies 14c are elastically deformed.

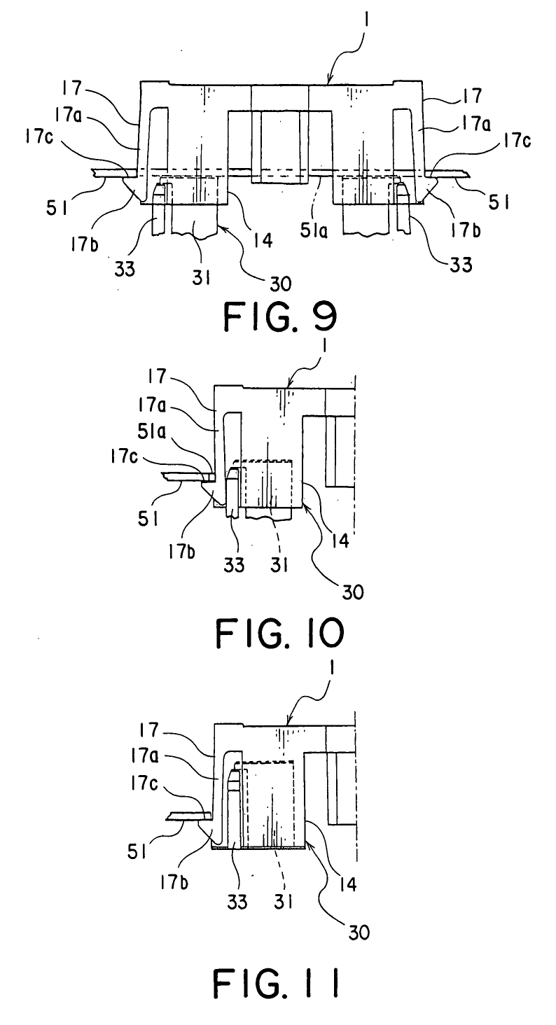

FIGS. 9 to 11 show the positional relationship between the first and second elastic bodies 17 and 19 and the first and second limiting portions 33 and 35 in the process of fitting the second connecting member 30 into the first connecting member 1.

FIG. 9 shows a state before the second connecting member 30 is temporarily attached to the first connecting member 1. In a temporary fitting state, as shown in FIG. 10, the additional elastic body 14c returns to a state before the temporary attachment. This is because the second connecting member 30 is locked by the first additional locking portion 14d after the additional elastic body 14c is deformed by the second block portion 32. In this event, the second connecting member 30 is locked to the first connecting member 1 in the temporary fitting state. In a complete fitting state, as shown in FIG. 11, elastic deformation of the first and second elastic bodies 17 and 19 is limited by the first and second limiting portions 33 and 35.

Incidentally, only the limiting portions 33 or 35 may be provided to limit the deformation of the corresponding first or second elastic bodies 17 or 19.

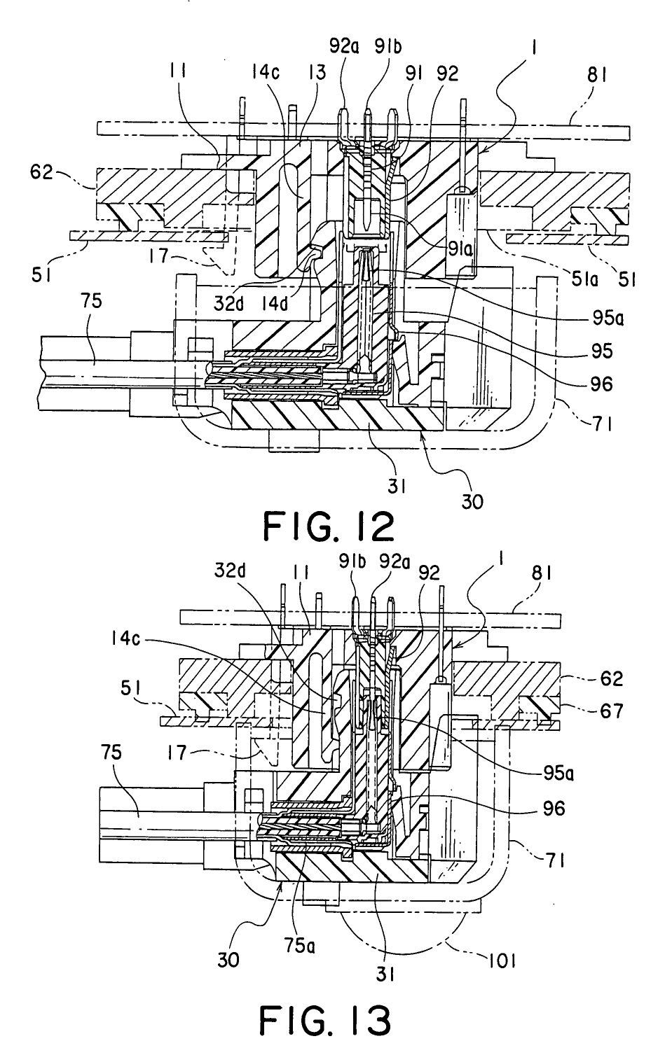

FIGS. 12 and 13 show, as a second embodiment of this invention, a configuration where a first connecting member 1 and a second connecting member 30 are applied to form an antenna device. The same components as those in the first embodiment are assigned the same reference symbols.

The antenna device is mounted to a roof panel 51. An antenna body 61 shown in FIG. 5 is disposed on one side of the roof panel 51. On the other side of the roof panel 51, there is disposed a fixing device 63 that serves to fix the antenna body 61 to the roof panel 51.

As shown in FIGS. 5 and 6, a base member 62 is mounted in an antenna cover 65. A patch antenna (not shown), a board 81 shown in FIG. 12, and the first connecting member 1 are mounted on the base member 62.

An additional elastic body 14c is formed in a first fitting hole 14a of the first connecting member 1. In the first fitting hole 14a, the additional elastic body 14c extends parallel to the axial direction of the first fitting hole 14a from a first base portion 13. A stripe-shaped first additional locking portion 14d is formed at a free end portion of the additional elastic body 14c.

In the first fitting hole 14a, a first contact 91 is provided parallel to the axial direction of the first fitting hole 14a. The first contact 91 comprises a first contact portion 91a extending toward one side from its holding portion held by the first base portion 13 of the first connecting member 1 and a first terminal portion 91 b extending from the other side of the holding portion so as to be connected to a circuit formed in the board 81.

The first contact 91 is held by a portion of the first connecting member 1. A first external conductor 92 is provided on a portion of an outer surface of the first contact 91. A first conductor terminal 92a of the first external conductor 92 is connected to a ground circuit of the board 81.

A groove-shaped second additional locking portion 32d is formed in a second fitting hole 32a of the second connecting member 30. The second additional locking portion 32d is located at an inner wall surface arranged parallel to the axial direction of the second fitting hole 32a.

In the second fitting hole 32a, a second contact 95 is provided parallel to the axial direction of the second fitting hole 32a. The second contact 95 has a second contact portion 95a extending to one end from its holding portion held by the second connecting member 30.

The other end of the second contact 95 is connected to a center conductor 75a of a cable 75. The second contact 95 is held by a portion of the second connecting member 30. A second external conductor 96 is provided on a portion of an outer surface of the second contact 95. The second external conductor 96 is connected to an external conductor of the cable 75.

In the middle of inserting and fitting the second connecting member 30 into the first connecting member 1, the second connecting member 30 is temporarily attached to the first connecting member 1. At the time of fitting after releasing the temporary attachment, the first and second contacts 91 and 95 are connected together. When the first connecting member 1 and the second connecting member 30 have been fitted together, a two-stage friction locking mechanism is provided by the first and second additional locking portions 14d and 32d.

The first connecting member 1, the patch antenna (not shown), for example, for a high frequency range, and the board 81 are attached to the antenna body 61. A terminal of the board 81 is connected to an antenna element 69 through a lead line. Thereafter, the antenna cover 65 is attached to the antenna body 61. In this event, in the fixing device 63 shown in FIG. 6, a bolt 101 is inserted into a through hole (not shown) formed in a cover body 71.

In a first process of temporarily attaching the first connecting member 1 to the roof panel 51, the second connecting member 30 is inserted into the first connecting member 1. In the first process, first and second locking portions 17c and 19c of first and second elastic bodies 17 and 19 engage with the back side of the roof panel 51. In this event, the first connecting member 1 is temporarily attached to the roof panel 51. Further, as shown in FIG. 12, the first additional locking portion 14d of the additional elastic body 14c enters the second additional locking portion 32d, thereby carrying out locking (temporary attachment) of a second process. In the temporary attaching state in the second process, the first contact portion 91a and the second contact portion 95a are not in contact with each other.

In a third process, as shown in FIG. 13, the second connecting member 30 is further inserted into the first connecting member 1, so that the first contact portion 91a and the second contact portion 95a are brought into contact with each other. In this event, the second external conductor 96 is brought into contact with the first external conductor 92 so as to be grounded. Further, the first additional locking portion 14d of the additional elastic body 14c and the second additional locking portion 32d are disengaged from each other, so that the additional elastic body 14c returns to the original shape.

Further, in the third process, after the first connecting member 1 and the second connecting member 30 have been fitted together, the cover body 71 is firmly fixed by screwing the bolt 101 into a threaded portion (not shown) formed in a tubular portion 62a.

At the time of the temporary attachment described in FIG. 12, the first and second contacts 91 and 95 are not in contact with each other. At the time of the complete fitting shown in FIG. 13, the first and second contacts 91 and 95 are brought into contact with each other.

Therefore, by checking electrical continuity, the complete fitting between the first connecting member 1 and the second connecting member 30 can be easily judged based on the presence or absence of electrical connection.

In the connecting device having the locking mechanism, the first elastic body 17 serves as a guide when temporarily attaching the first connecting member 1 to the roof panel 51.

Therefore, when attaching the first connecting member 1 to the roof panel 51, it is possible to reduce an insertion force. Further, when attaching the first and second connecting members 1 and 30 to the roof panel 51, it is possible to simplify the mounting operation and thus to reduce a load of a mounting dealer.

Further, it is possible to ensure a mounting strength of the first connecting member 1 to the roof panel 51 so as to bear a load applied when the second connecting member 30 is fitted thereto.

Further, it is possible to temporarily attach the second connecting member 30 to the first connecting member 1 by one-touch operation with one hand.

Therefore, in the process subsequent to the temporary attachment in the mounting operation, it is possible to smoothly shift to the screwing operation using a tool for fixing the second connecting member 30.

A connecting device having a locking mechanism of this invention is also applicable to a use such as a switch connector or a vehicle body connector. The switch connector is adapted to connect and disconnect a circuit by insertion and removal operations thereof. The body connector is fixed to a vehicle body on the door side or the body side at a portion where a door portion and a body portion are separated from each other, wherein another connector is connected thereto after the fixation.

What is claimed is:

1. A connecting device having a locking mechanism for locking fitting between a first connecting member and a mating side,
wherein said first connecting member comprises a first housing,
said first housing has the locking mechanism,
said locking mechanism comprises a first elastic body and a second elastic body,
said first elastic body has a first contact portion adapted to contact said mating side,
said second elastic body has a second contact portion adapted to contact said mating side,
at least one of said first elastic body and said second elastic body has a locking portion adapted to lock fitting to said mating side.

2. The connecting device according to claim 1, wherein said first contact portion contacts with said mating side to elastically deform said first elastic body when said first connecting member fits to said mating side, and then, said second contact portion contacts with said mating side to elastically deform said second elastic body.

3. The connecting device according to claim 1, further comprising a second connecting member for connection to said first connecting member,
wherein said second connecting member comprises a second housing, and
said second housing has a limiting portion adapted to limit deformation of at least one of said first elastic body and said second elastic body when said second connecting member is connected to said first connecting member.

4. The connecting device according to claim 3, wherein said first housing is provided with a first contact and said second housing is provided with a second contact adapted to be connected to said first contact when said second connecting member is fitted to said first connecting member.

5. The connecting device according to claim 4, wherein said first contact and said second contact are connected together after said first connecting member and said second connecting member are fitted together.

6. The connecting device according to claim 5, wherein said first housing has an additional elastic body, said additional elastic body has a first additional locking portion, and said second housing has a second additional locking portion adapted to engage with said first additional locking portion so as to temporarily attach said second connecting member to said first connecting member in the middle of inserting and fitting said second connecting member into said first connecting member.
